(19) United States
(12) Patent Application Publication
(10) Pub. No.: US 2019/0184788 A1
(43) Pub. Date: Jun. 20, 2019

(54) METHOD AND SYSTEM OF CONTROLLING CLIMATE CONTROLLED ZONES IN A VEHICLE BASED ON OCCUPANT PRESENCE

(71) Applicant: Dura Operating, LLC, Auburn Hills, MI (US)

(72) Inventors: Aaron Brion Stachewicz, Troy, MI (US); Patricia Machado, Detroit, MI (US)

(21) Appl. No.: 15/848,799

(22) Filed: Dec. 20, 2017

(51) Int. Cl. B60H 1/00; G06K 9/00

(52) U.S. Cl. CPC B60H 1/00742; B60H 1/00657; B60H 1/00064; B60H 1/00842; B60H 2001/002; G06K 9/00838

(57) ABSTRACT

A method for controlling environmental parameters in a vehicle having multiple climate controlled zones is provided in the disclosure. The method includes determining whether a climate controlled zone is occupied by a user. If the climate controlled zone is not occupied by a user, then a status of “non-occupied” is assigned to the climate controlled zone. If the climate controlled zone is occupied by a user, then the a status of “occupied” is assigned to the climate controlled zone, identifies the user, and retrieves from a database a user profile linked to the identified user. The user profile includes predetermined environmental parameter settings such air temperature, air flowrate, airflow direction, and seating temperature. The controller than adjust at least one environmental parameter for the climate controlled zone to match the predetermined environmental parameter settings. A system is provided for the implementation of the method.

### FIELD

The invention relates generally to a system and method of controlling climate in a vehicle, more particularly to a system and method of controlling climate within a climate controlled zone.

### BACKGROUND

The statements in this section merely provide background information related to the present disclosure and may or may not constitute prior art.

Vehicle climate control systems such as air conditioning systems provides the vehicle occupants with a comfortable environment during hot or cold ambient driving conditions. A typical air conditioning system includes an evaporator, a heater core, and a blower assembly. The blower assembly induces a flow of air over the evaporator and/or heater core to provide conditioned air to a passenger cabin of the vehicle. In cooling mode, ambient and/or recycled cabin air is passed over the evaporator to remove heat energy and moisture from the air, thereby providing cooled and dehumidified conditioned air to the passenger cabin. In heating mode, ambient, recycled cabin air, and/or a portion of the conditioned air from the evaporator is passed over the heater core to add heat energy, thereby providing warmed conditioned air to the passenger cabin.

A compressor is used to circulate a refrigerant through the evaporator and a coolant pump is used to circulate a hot coolant through the heater core. The compressor and coolant pump are typically driven by a power takeoff from the engine of the vehicle; thereby increasing demand on the engine resulting in increased energy usage. In smaller vehicles such as a subcompact or compact car, the energy difference utilized to provide conditioned air to the occupied areas of the vehicle as compared to providing conditioned air to the entire passenger cabin, including non-occupied areas, may be negligible. However, for larger vehicles such as a three row sport utility vehicle or mini-van, the energy difference may be substantial greater. For even larger vehicles such as buses, subway trains, and passenger planes, the energy difference required to provide conditioned air to the entire passenger cabin as opposed only to occupied areas of the passenger cabin is even substantially greater.

For vehicles having multiple climate controlled zones, environmental parameters such as temperature, air flowrate, and even direction of air deliver may be adjusted by an occupant for the climate controlled zone in which the occupant occupies. Once the occupant leaves the climate controlled zone, the environmental parameters are typically retained at their previous setting, thereby wasting energy. When a new occupant occupies the climate controlled zone, the new occupant would need to re-adjust the environmental parameters to the new occupant's preferences, thereby causing a minor inconvenience for the new occupant.

Thus, while current climate control systems achieve their intended purpose, there is a need for a new and improved method and system for controlling environmental parameters in a climate controlled zone based on the occupant presence to reduce energy usage while anticipating the preferred settings of the environmental parameters of the occupant.

### SUMMARY

According to several aspects, a method for controlling environmental parameters in a vehicle having multiple climate controlled zones is provided in the disclosure. Environmental parameters include a conditioned air temperature, a conditioned air flow rate, a conditioned air flow direction, and/or a seating temperature. The method includes the steps of determining, by a controller, whether a climate controlled zone is occupied by a user. If the climate controlled zone is not occupied by a user, then the controller assigns a status of “non-occupied” to the climate controlled zone. If the climate controlled zone is occupied by a user, then the controller assigns a status of “occupied” to the climate controlled zone, identifies the user, and retrieves from a database a user profile linked to the identified user. The user profile includes predetermined environmental parameter settings. The controller can adjust at least one environmental parameter for the climate controlled zone to match the predetermined environmental parameter settings.

In an additional aspect of the present disclosure, the method further includes the step of activating, by the controller, a human machine interface (HMI) configured for the user to manually adjust the environmental parameter.

According to several aspects, the method further includes the steps of inventorying, by the controller, the status of an adjoining climate controlled zone immediately adjacent the climate controlled zone occupied by the user, and syncing the adjustment of the environmental parameters of the adjoining climate controlled zone to the HMI, if the status of the adjoining climate controlled zones is non-occupied.

According to several aspects, the HMI is a portable electronic communication device and the user profile is uploaded to the database from the portable electronic communications device.

According to several aspects, the step of determining whether the climate controlled zone is occupied by the user includes the step of using the portable electronic and/or electronic communication device to communicate with the controller using near field communications (NFC) through a NFC receiver or similar technology such as pairing an electronic device through bluetooth located within the climate controlled zone.

According to several aspects, the steps of determining whether the climate controlled zone is occupied by a user and identifying the user includes capturing an image, by an imaging sensor, of the climate controlled zone; analyzing the image to detect the user and a biometric feature of the user; comparing and matching the biometric feature of the user with biometric features stored in the database; and identify the user based on a matching biometric feature.

According to several aspects, the steps of determining whether the climate controlled zone is occupied by a user and identifying the user includes entering a passcode into a keypad.

According to several aspects, the method further includes the step of defaulting to preset environmental parameters if the climate controlled zone has the status of non-occupied.

According to several aspects, a method of controlling a heating, ventilation, and air-conditioning (HVAC) system for a vehicle having a plurality of climate controlled zones is provided in the disclosure. The method includes the steps of defining a plurality of climate controlled zones within the vehicle, wherein at least one zone of the climate controlled zones is configured such that an environmental parameter is adjustable; detecting an object within the at least one zone; determining whether the object is an animate or inanimate object if an object is detected; and assigning a status of “non-occupied” to the climate controlled zone if no object is detected or if the object is inanimate.

In an additional aspect of the present disclosure, the step of determining whether the object is an animate or inanimate object includes the steps of capturing an image of the object and processing the image to detect movement of the object and assigning a status of “animate” if movement is detected.

In another aspect of the present disclosure, the method further includes the steps of processing the image to determine whether the animate object is a person and assigning a status of “occupied” and activating a human machine interface (HMI) within the at least one zone for adjusting predetermined environmental parameter setting if the animate object is determined to be a person.

In another aspect of the present disclosure, the method further includes the steps of determining the status of adjoining climate controlled zones and syncing control of an environmental parameter of the adjoining climate controlled zone to the HMI if the status of the adjoining climate controlled zone is non-occupied. The HMI may be that of a portable computing device

In another aspect of the present disclosure, the method further includes the steps of capturing, by an image capturing device, an image of the person; analyzing, by a controller, the image to identify the person; retrieving, from a database, a user profile linked to the identified person, wherein the user profile includes a predetermined environmental parameter setting, and adjusting the environmental parameter to match the predetermined environmental parameter setting to the at least one zone. The user profile may be uploaded to the database from the portable computing device.

In another aspect of the present disclosure, the method further includes the steps of registering the portable computing device and user profile with the controller by using near field communications (NFC) through a NFC receiver Bluetooth or similar technology linked to the at least one zone.

According to several aspects, a system for adjusting environmental parameters for at least one of a plurality of climate controlled zones within a vehicle is provided in the disclosure. The system includes a HVAC module having a heater core configured to provide heated air and an evaporator configured to provide cooled air; a layout of air ducts in fluid connection with the HVAC module for directing the heated air and the cooled air to the plurality of climate controlled zones. The air ducts include a plurality of actuated blend doors configured to blend the heated air and cooled air; an image capturing device configured to capture an image from one of the climate controlled zone; and an controller in communication with the actuated blend doors and image capturing device. The controller is configured to analyze the image to detect and identify a user occupying the at least one climate controlled zone, retrieve a user profile linked to the identified user, and deliver conditioned air to the at least one climate controlled zone occupied by the user based on the user profile. The controller may also be configured to adjust the temperature setting on a temperature controlled seat located within the at least one climate controlled zone.

In an additional aspect of the present disclosure, the system further includes a human machine interface (HMI) accessible by the user within the at least one climate controlled zone for adjusting the environmental parameter. The controller is in communication with the HMI.

In another aspect of the present disclosure, the controller is further configured to determine whether the status of an immediate adjoining climate controlled zone is occupied or non-occupied, and sync the HMI to adjust the environmental parameters of the adjoining climate controlled zone if the status is non-occupied.

In another aspect of the present disclosure, the system further includes a data base containing the user profile accessible by the controller. The user may upload the user profile through the HMI to the data base.

The method and system provides the benefit of saving energy and fuel for the vehicle by providing climate control to climate control zones that are occupied by a human user. The method and system also provides the advantages of setting environmental parameters in accordance with the user's uploaded preferences. Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is an illustration of a top view of a passenger compartment of a vehicle having multiple climate controlled zones, according to an exemplary embodiment;

FIG. 2 is schematic illustration of a climate control system for the vehicle of FIG. 1, according to an exemplary embodiment;

FIG. 3 is a schematic illustration of a controller for the climate control system shown in FIG. 2 and

FIG. 4 is a block diagram for a method of controlling the multiple climate controlled zones, according to an exemplary embodiment.

### DETAILED DESCRIPTION

The following description is merely exemplary in nature and is not intended to limit the present disclosure, application, or uses.

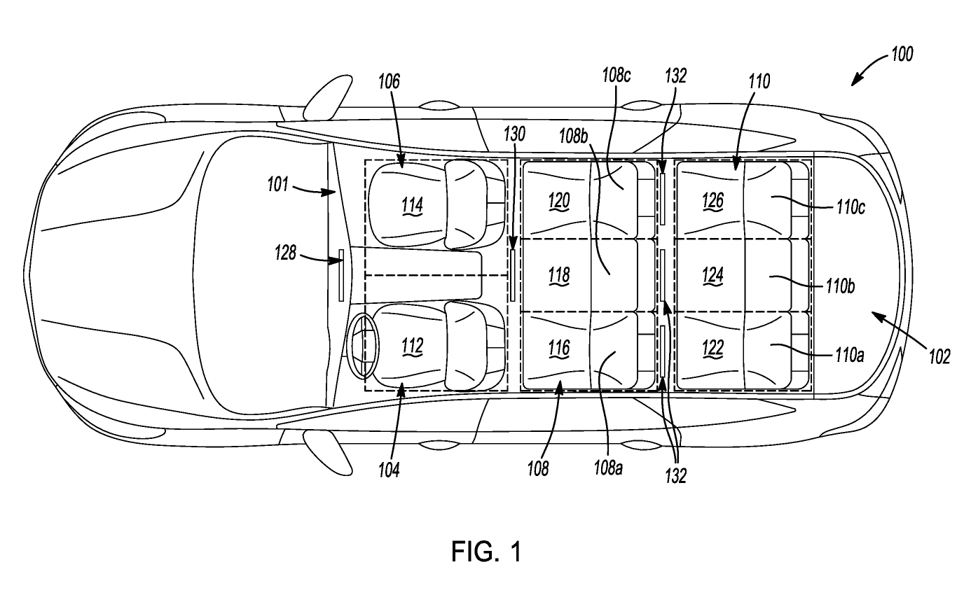

FIG. 1 shows a top view of an exemplary vehicle 100 showing a cutaway view of a passenger cabin 102. Adjacent a forward instrument panel 101 of the passenger cabin 102 is a driver seating area 104 and a passenger seating area 106. A second row seating 108 is located immediately behind the driver seating area 104 and the passenger seating area 106. A third row seating 110 is located immediately behind the second row seating area 108. The second row seating 108 include three seating areas 108a, 108b, 108c for passengers. Similarly, the third row seating 110 includes three seating areas 110a, 110b, 110c.

The passenger cabin 102 includes a plurality of climate controlled zones, in which a climate controlled zone is defined about a respective seating area. A climate controlled zone includes the volume of space about the seating area that a passenger occupies while seated in the seating area. The climate controlled zone also includes the volume of space in which the occupant would have a reasonable freedom of movement while occupying the seating area. The boundaries of the climate controlled zones are shown in dashed lines within the passenger cabin 102.

A first climate control zone 112 and a second climate control zone 114 are defined about the driver seating area 104 and passenger seating area 106, respectively. A third climate controlled zone 116, a fourth climate controlled zone 118, and a fifth climate controlled zone 120 are defined in the second row seat 108 about the three seating areas 108a, 108b, 108c, respectively. A sixth climate controlled zone 122, a seventh climate controlled zone 124, and an eighth climate controlled zone 126 are defined in the third row seat 110 about the three seating areas 110a, 110b, 110c respectively. Immediately adjacent climate controlled zones may slightly overlap each other. However, the effect of an environment parameter setting in one climate zone should have a minimal to negligible effect on the environment parameter setting in the adjacent climate controlled zone as noticeable by a passenger in each of the respective zones. Examples of environmental parameters include air temperature, airflow rate, airflow direction, and seating temperature.

Access to a human machine interface (HMI) is provided in each climate controlled zone. The HMI enables the passenger in each climate controlled zone to manually adjust settings for the environmental parameters for passenger comfort. A center primary HMI 128 is shown in the forward instrument panel 101 of the vehicle 100. The center primary HMI 128 is configured to enable the driver and front passenger to adjust the environmental parameters for all eight climate control zones 112 through 126 as a single zone. The center primary HMI 128 may also be configured to enable the driver and front passenger to adjust the environmental parameters for each of the eight climate control zones 112 through 126 individually, in which each climate control zone may have the same or different environmental parameter settings. For the second row seating 108, a center secondary HMI 130 may be provided for access by occupants in the third, fourth, and fifth climate controlled zones 116, 118, 120. Separate individual HMIs 132 may be provided for the sixth, seventh, and eight climate controlled zones 122, 124, 16. The HMIs may include a keypad configured for a user to enter a predetermined passcode associated with a user's profile. Alternatively, a portable electronic device 134 such as a smart phone, tablet, computer, and the likes may be used as a portable HMI 134 to control the environmental parameters in a climate controlled zone where the portable electronic device 134 is located within.

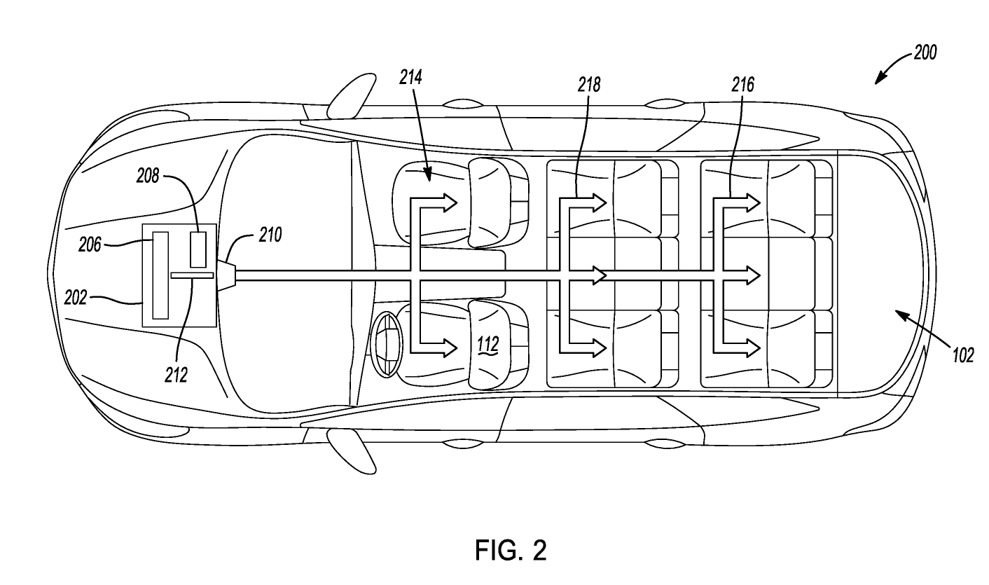

FIG. 2 shows a climate control system 200 for the passenger cabin 102 of the vehicle 100 shown in FIG. 1. The climate control system 200 includes a HVAC module 202 located near or within the dashboard 101 of the vehicle 100. The HVAC module 202 houses an evaporator 206 and a heater core 208, and may be integral with a blower assembly 210. The blower assembly 210 includes a blower fan (not shown) configured to induce an airflow passing over the evaporator 206 and heater core 208 to provide conditioned air to the passenger cabin 102. While only one HVAC module 202 is shown, it should be appreciated that more than one HVAC module 202 may be utilized. For example, a primary HVAC module may be dedicated to the front seating areas 104, 106 and second seating row 108, while a secondary or tertiary HVAC module may be located adjacent the rear of the vehicle 100 to provide conditioned air to the third row seating area 110.

As exterior ambient and/or recycle airflow from the passenger cabin 102 is passed over the evaporator 206, thereby cooling and dehumidifying the airflow. A variable mix valve 212 is provided downstream of the evaporator 206 and upstream of the heater core 208 for selecting portions of the cooled and humidified airflow for bypassing to the heater core 208. A selected portion of airflow from the evaporator 206 may be passed over the heater core 208, thereby warming the selected portion of airflow. Extending from the discharge of the HVAC module 202 is a myriad network of air ducts 214. The network of air conduits 214 is laid out to convey conditioned airflow exiting the HVAC module 202 to each of the eight climate controlled zones 112 through 126.

The air ducts 214 may be partitioned into two or more separate flow paths (not shown) where one of the flow paths may conduct a flow of cooled air directly from the evaporator 206 and another of the flow paths may conduct a flow of warmed air from the heater core 208. An electrically operated blend valve 216 is provided in each outlet end 218 of the air duct 214 that is dedicated to a particular climate control zone. The electrically operated blend valve 216 blends the warmed and cold air to provide a temperature of conditioned air that is desired for that particular climate controlled zone. While an exemplary network of air ducts 214 are described herein, it should be appreciated that alternate layouts of networks of air ducts 214 may be utilized without departing from the scope of the invention.

An electrically actuated restriction valve (not shown) may be provided at the each outlet end 218 for each climate controlled zone for the control of airflow rate to each climate controlled zone. The outlet end 218 of the air ducts 214 may include louvered vents or adjustable nozzles (not shown), in which the louver vents or nozzle are adjustable by electric actuators to direct the airflow to a particular area of the climate controlled zone. To further extend the temperature range of the air discharge beyond what is capable from the warm air flow alone, cooled air flow alone, or a combination of warmed and cooled air flow, a thermoelectric device (not shown) may be provided adjacent the outlet end 218 of each of the air ducts 214. To further enhance the comfort of the passenger in a climate controlled zone 218, the climate control system may also include a temperature controlled seat 218 in which the temperature setting of the seat 218 may be adjusted.

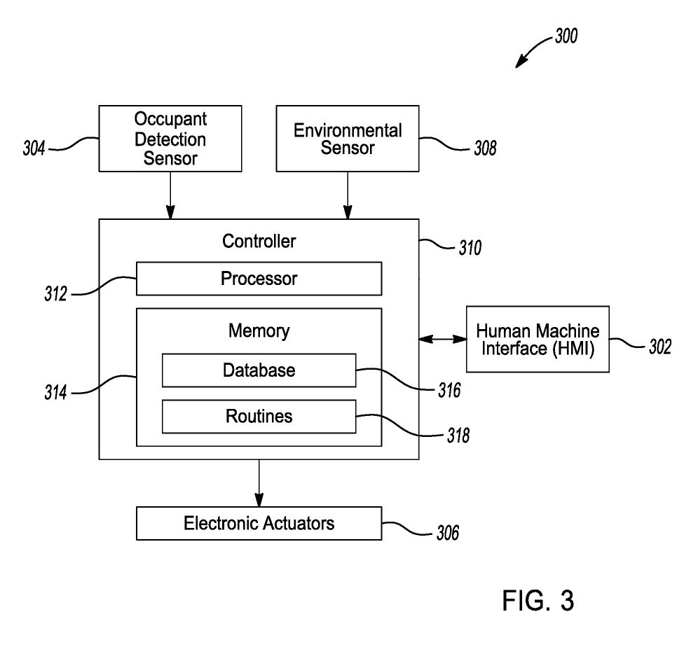

FIG. 3 shows a climate control system 300 for the controlling of environmental parameters for each of the climate controlled zones. The climate control system 300 includes a human machine interface (HMI) 302, similar to the HMIs described above, for controlling the environmental parameters, an occupant detection sensor 304 configured to detecting whether a climate controlled zone is occupied; electronic actuators 306 for controlling the airflow, temperature of airflow, and flow rate of airflow to each zone; environmental sensors 308; and a controller 310. The controller 310 is in communications with the HMI 302, occupant detection sensor 304, electronic actuators 306, and environmental sensors 308.

The occupant detection sensors 304 utilized for occupant detection may include infrared sensors, motion sensors, range sensors, pressure sensors, or image sensors. It is preferable that image sensors are utilized, since software routines may be provided to analyze the image to recognize the type and particulars of the image. For example, the image may be analyzed to determine if there is movement, whether the object is a person or animal, and/or to further characterize the object or person. The identity of the person may be determined by analyzing biometric features that may be uploaded into a database. Environmental sensors 308 may include air-mass flowrate sensors, humidity sensors, thermocouples, and the likes.

The controller 310 includes a processor 312 and a memory device 314 having a database 316 and stored routines 318 accessible by the processor. The processor 312 may be any conventional processor, such as commercially available CPUs, dedicated application-specific integrated circuit (ASIC), or other hardware-based processor. The memory device 314 may be any computing device readable medium such as hard-drives, solid state memory, ROM, RAM, DVD or any other medium that is capable of storing information that is accessible by the processor 312. The controller 310 may also be that of a micro-controller having a micro-processor, memory device, and other peripherals embedded on a single integrated circuit.

Although only one controller 310 is shown, it is understood that the vehicle may contain multiple controllers 310. Each of the controllers 310 may include more than one processor and memory, and the plurality of processors and memories do not necessary have to be housed within the respective controllers. Accordingly, references to a controller, processor, and memory devices include references to a collection of such controllers, processors, and memory devices that may or may not operate in parallel

The routines 318 may include algorithms to determine whether a climate controlled zone is occupied, and if occupied then determine whether there is movement within the climate controlled zone and type of object occupying the climate controlled zone. The routines also include algorithms to adjust the environmental parameters for each of the climate controlled zone based on uploaded passenger preferences stored in the database.

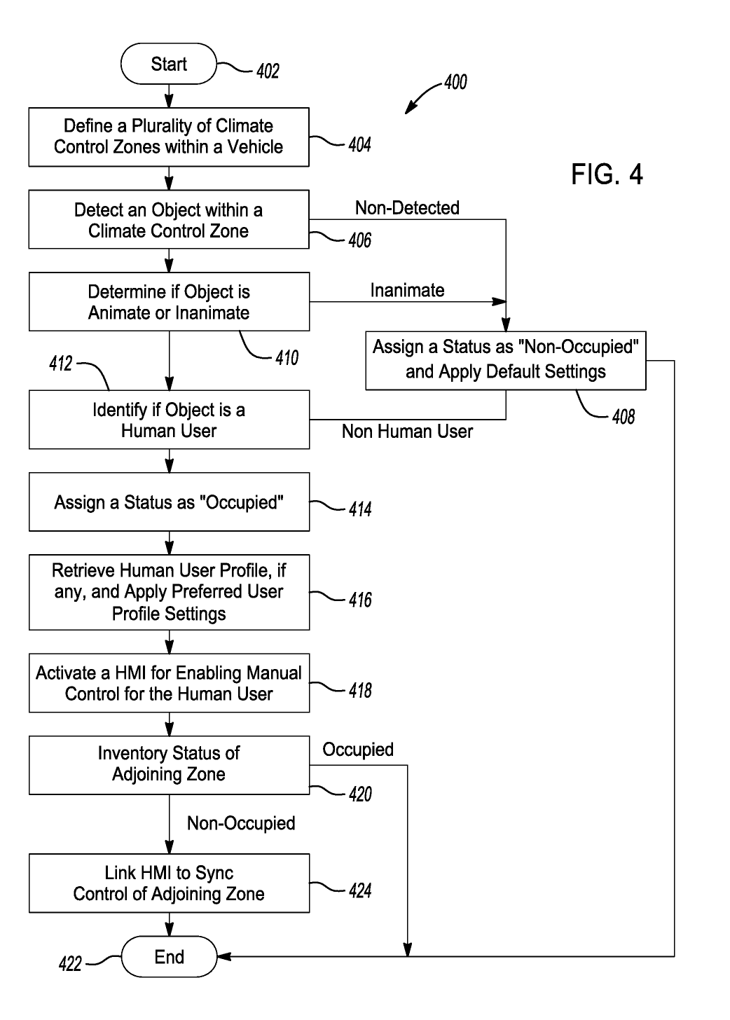

FIG. 4 is a block flow diagram of a method of controlling a climate control system for a vehicle having a plurality of climate controlled zones. The method includes controlling environmental parameters in the climate controlled zones.

The method starts in block 402. In block 404, a plurality of climate controlled zones are defined within the vehicle. At least one zone of the climate controlled zones is configured such that an environmental parameter is adjustable.

In block 406, the occupant detection sensors detects whether there is an object within the at least one zone. If an object is not detected, then in block 408, a status of “non-occupied” is assigned and a default setting of environmental parameters are provided for the at least one zone.

If an object is detected, then in block 410 a determination is made as to whether the object is animate or inanimate. An image of the object is captured by an imaging sensor, such as an electronic camera. The image is processed by the controller or an ASIC to detect movement of the object. A status of “animate” is assigned if movement is detected and “inanimate” if no movement is detected. If the object is determined to be inanimate, then in block 408, a status of “non-occupied” is assigned and a default setting of environmental parameters are provided for the at least one zone.

If the object is determined to be animate, then in block 412, the image is further processed to determine whether the animate object is a human user. If the object is determined not to be a human user, then in block 408, a status of “non-occupied” is assigned and a default setting of environmental parameters are provided for the at least one zone.

If the animate object is determined to be a human user, then in block 414, a status of “occupied” is assigned to the climate controlled zone. In block 416, the image is further process and compared with biometric data stored in the database to identify the human user and the preferred environmental parameter settings for the human user. A user profile, including the identity of the human user and the preferences of the human user, is stored in a database located onboard of the vehicle or on an off vehicle database, such as a web server. If a user profile match is found, the user profiled is accessed by the controller and the environmental parameters are set in accordance with the preferred settings in the user profile.

In block 418, a human machine interface (HMI) is activated to enable the human user to manually adjust the environmental parameter. The HMI may be an instrument panel or graphical user interface accessible by the human user in the at least one climate controlled zone. Alternatively, the HMI may be a portable computing device, such as a smart phone, bought on board the vehicle by the human user. The user profile may be registered with the controller by using near field communications (NFC) through a NFC receiver, Bluetooth, or similar technology linked to the at least one zone. The user profile may be stored on a NFC enabled card carried by the human user and uploaded to the controller by swiping or tapping the card on the NFC receiver.

In block 420, the status of adjoining climate controlled zones is determined and inventoried. If the status of the adjoining climate controlled is occupied, then the method ends in block 422.

In block 424, if the status of the adjoining climate controlled zone is non-occupied, then the HMI is synced to enable control of the environmental parameter of the adjoining climate controlled zone. The method ends in block 422.

The method and system for climate control for a vehicle having a plurality of climate controlled zone of the present disclosure offers several advantages. These advantages include the benefit of saving energy and fuel for the vehicle by providing climate control to climate control zones that are occupied by a human user. The method and system also provides the advantages of setting environmental parameters in accordance with the user's uploaded preferences. The method and system disclosed herein may be scaled up for operations in buses, trains, and/or airplanes.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

What is claimed is:

1. A method for controlling environmental parameters in a vehicle having multiple climate controlled zones, comprising the steps of:
determining, by a controller, whether a climate controlled zone is occupied by a user;
if the climate controlled zone is not occupied by a user, then the controller assigns a status of “non-occupied” to the climate controlled zone; or
if the climate controlled zone is occupied by a user, then the controller:
assigns a status of “occupied” to the climate controlled zone,
identifies the user,
retrieves, from a database, a user profile linked to the identified user, wherein the user profile includes predetermined environmental parameter settings, and
adjust an environmental parameter for the climate controlled zone to match the predetermined environmental parameter settings, wherein the environmental parameter includes at least one of a conditioned air temperature, a conditioned air flow rate, a conditioned air flow direction, and a seating temperature.

2. The method of claim 1, further comprising the step of activating, by the controller, a human machine interface (HMI) configured for the user to manually adjust the environmental parameter.

3. The method of claim 2, further comprising the steps of:
inventorying, by the controller, the status of an adjoining climate controlled zone immediately adjacent the climate controlled zone occupied by the user; and
syncing the adjustment of the environmental parameters of the adjoining climate controlled zone to the HMI, if the status of the adjoining climate controlled zones is “non-occupied”.

4. The method of claim 2, wherein the HMI is a portable electronic communication device or a key pad device, wherein the key pad device is configured to accept a predetermined code associated with the user profile.

5. The method of claim 4, wherein the user profile is uploaded to the database from the portable electronic communications device or from a near field communications (NFC) enabled card.

6. The method of claim 4, wherein the step of determining whether the climate controlled zone is occupied by the user includes the step of using the portable electronic communication device to communicate with the controller using near field communications (NFC) through a NFC receiver located within the climate controlled zone.

7. The method of claim 1, wherein the steps of determining whether the climate controlled zone is occupied by a user and identifying the user includes:
capturing an image, by an imaging sensor, of the climate controlled zone;
analyzing the image to detect the user and a biometric feature of the user;
comparing and matching the biometric feature of the user with biometric features stored in the database; and
identify the user based on a matching biometric feature.

8. The method of claim 1, further comprising the step defaulting to preset environmental parameters if the climate controlled zone has the status of non-occupied.

9. A method of controlling a climate control system for a vehicle having a plurality of climate controlled zones, comprising the steps of:
defining a plurality of climate controlled zones within the vehicle, wherein at least one zone of the climate controlled zones is configured such that an environmental parameter is adjustable;
detecting an object within the at least one zone;
determining whether the object is an animate or inanimate object if an object is detected; and
assigning a status of “non-occupied” to the at least one zone if no object is detected or if the object is inanimate.

10. The method of claim 9, wherein the step of determining whether the object is an animate or inanimate object includes the steps of capturing an image of the object and processing the image to detect movement of the object, and assigning a status of “animate” if movement is detected.

11. The method of claim 10, further comprising the steps of:
processing the image to determine whether the animate object is a person;
assigning a status of “occupied” and activating a human machine interface (HMI) within the at least one zone for adjusting the default environmental parameter if the object is determined to be animate and a person.

12. The method of claim 11, further comprising the steps of:
determining the status of adjoining climate controlled zones; and
syncing control of an environmental parameter of an adjoining climate controlled zone to the HMI if the status of the adjoining climate controlled zone is non-occupied.

13. The method of claim 12, wherein the HMI is a portable computing device.

14. The method of claim 13, further comprising the steps:
capturing, by an image capturing device, an image of the person;
analyzing, by a controller, the image to identify the person;
retrieving, from a database, a user profile linked to the identified person, wherein the user profile includes a predetermined environmental parameter setting; and
providing conditioned air based on the predetermined environmental parameter setting to the at least one zone.

15. The method of claim 14, wherein the user profile is uploaded to the database from the portable computing device.

16. The method of claim 15, further comprising registering the portable computing device and the user profile with the controller by using near field communications (NFC) through a NFC receiver linked to the at least one zone.

17. A system for adjusting environmental parameters for at least one of a plurality of climate controlled zones within a vehicle, comprising:
a HVAC module having a heater core configured to provide heated air and an evaporator configured to provide cooled air;
a layout of air ducts in fluid connection with the HVAC module for directing the heated air and the cooled air to the plurality of climate controlled zones, wherein the air ducts include a plurality of actuated blend doors configured to blend the heated air and cooled air;
an image capturing device configured to capture an image from one of the climate controlled zone; and
a controller in communication with the actuated blend doors and image capturing device, wherein the controller is configured to analyze the image to detect and identify a user occupying the at least one climate controlled zone, retrieve a user profile linked to the identified user, and deliver conditioned air to the at least one climate controlled zone occupied by the user based on the user profile.

18. The system of claim 17, further comprising a human machine interface (HMI) accessible by the user within the at least one climate controlled zone for adjusting the environmental parameter, wherein controller is in communication with the HMI.

19. The system of claim 18, wherein the controller is further configured to determine whether the status of an immediate adjoining climate controlled zone is occupied or non-occupied, and sync the HMI to adjust the environmental parameters of the adjoining climate controlled zone if the status is non-occupied.

20. The system of claim 19, further comprising a data base containing the user profile accessible by the controller, wherein the user uploads the user profile through the HMI to the data base.
